(19) United States
(12) Patent Application Publication
(10) Pub. No.: US 2018/0312944 A1
(43) Pub. Date: Nov. 1, 2018

(54) EXTRUDED PRODUCT MADE FROM AL-CU-MG ALLOY WITH IMPROVED COMPROMISE BETWEEN MECHANICAL RESISTANCE AND TOUGHNESS

(71) Applicant: CONSTELLIUM ISSOIRE, Issoire (FR)

(72) Inventors: Bernard BES, Seyssins (FR); Gaëlle POUGET, Grenoble (FR); Jérome PIGNATEL, La Chapelle Sur Erdre (FR)

(21) Appl. No.: 15/756,322

(22) PCT Filed: Sep. 1, 2016
(86) PCT No.: PCT/FR2016/052167

§ 371 Date: Feb. 28, 2018

(30) Foreign Application Priority Data
Sep. 3, 2015 (FR) 15/58153

(51) Int. Cl. C22C 21/18; C22F 1/057; C22C 21/14; C22C 21/16; B21C 23/08; F02F 3/00

(52) U.S. Cl. CPC C22C 21/18; C22F 1/057; C22C 21/14; F05C 2201/021; B21C 23/08; F02F 3/0084; C22C 21/16

(57) ABSTRACT

The invention relates to an extruded product made from an alloy of composition (% by weight):
Cu: 5.05-5.35 Mg: 0.20-0.40 Mn: 0.20-0.40 Zr: 0.08-0.15 Ti: 0.01-0.15 Zn: 0-0.15 Si<0.10 Fe<0.15 and other elements<0.05 each and <0.15 in total, the remainder being Al, treated by solution heat treatment, at a temperature between 525 and 540° C., quenching, controlled stretching during quenching until a permanent set of at least 1.5% is achieved, and ageing at a temperature of between 160 and 190° C. The products according to the invention are particularly well suited to use as pistons in an internal combustion engine of a vehicle and, in particular, of a racing car.

### FIELD OF THE INVENTION

The invention relates to extruded products made from Al—Cu—Mg alloy in the temper treated by solution heat treatment, quenching and ageing, and having, in relation to the products of the prior art, an improved compromise between the different properties of use required.

### STATE OF THE ART

Extruded products made from Al—Cu—Mg alloy have numerous applications, in particular, in the aerospace industry, the automotive industry, lorry and train production, the defence industry and general industrial applications such as ventilation systems, compressors or pistons.

These products can, in particular, be used in the extruded state or in the wrought state of an extruded bar.

The properties required for these products are, in particular, mechanical strength and damage tolerance. It is, in particular, advantageous to simultaneously obtain high mechanical strength and high toughness, these two properties generally being conflicting. Thus, a compromise between mechanical strength and toughness is generally spoken about.

Numerous alloys have been developed, in particular, for these extruded products. U.S. Pat. No. 5,376,192 defines alloys that have improved combinations of mechanical strength and toughness that have for composition (in % by weight) Cu: 2.5-5.5; Mg: 0.10-2.30 with minor additions of grain refiner and dispersoid elements. The quantities of Cu and Mg are adjusted such that the limit of solubility for these elements is not exceeded and preferably Cu=−0.91(Mg)+5.2.

Patent application EP 1 114 877 A1 defines a composition structure element (in % by weight) Cu: 4.6-5.3; Mg: 0.10-0.50; Mn 0.15-0.45; Si<0.10; Fe<0.15; Zn<0.20; Cr<0.10 and other elements<0.05 each and 0.15 in total, the remainder being aluminium treated by solution heat treatment, quenching, controlled stretching at more than 1.5% permanent set and ageing. The alloy contains manganese but comprises no other anti-recrystallizing element such as vanadium or zirconium.

Patent application US 2005/0081965 defines a wrought alloy product of composition (in % by weight) Cu: 4.4-5.5; Mg: 0.3-1.0; Fe: 0-0.20; Si; 0-0.20; Zn: 0-0.40; Mn: 0.15-0.8 as a dispersoid element combined with and/or plus a dispersoid element chosen in the group consisting of Zr, Sc, Cr, Hf, Ag, Ti and V; the remainder being aluminium wherein the Cu and Mg contents are such that −1.1[Mg]+5.38≤[Cu]≤5.5.

Patent application WO 2012/140337 relates to Al—Cu—Mg alloys of composition, in % by weight, Cu_{corr}: 2.6-3.7; Mg_{corr}: 1.5-2.6; Mn: 0.2-0.5; Zr: ≤0.16; Ti: 0.01-0.15; Cr≤0.25; Si≤0.2; Fe≤0.2; and other elements<0.05 and the remainder being aluminium; with Cu_{corr}>−0.9(Mg_{corr})+4.3 and Cu_{corr}<−0.9 (Mg_{corr})+5.0; where Cu_{corr}=Cu−0.74 (Mn−0.2)−2.28 Fe and Mg_{corr}=Mg−1.73 (Si−0.05) for Si≥0.05 and Mg_{corr}=Mg for Si<0.05 and their method of production.

The aim of this invention is to supply extruded products that have properties with an improved compromise of properties between high mechanical strength and toughness.

### AIM OF THE INVENTION

The invention aims for an extruded product made from alloy of composition (% by weight):

Cu: 5.05-5.35 Mg: 0.20-0.40 Mn: 0.20-0.40 Zr: 0.08-0.15 Ti: 0.01-0.10 Zn: 0-0.15 Si<0.10 Fe<0.15

and other elements<0.05 each and <0.15 in total, the remainder being Al, treated by solution heat treatment, quenching, controlled stretching and ageing.

The invention also aims for a method for producing an extruded product according to the invention comprising:
a) the casting of an unwrought product of the composition according to the invention,
b) the homogenising of this unwrought product,
c) the hot forming by extrusion of a billet obtained from this unwrought product homogenised as such, to obtain an extruded product,
d) the solution heat treatment of this extruded product, at a temperature of between 525 and 540° C.,
e) the quenching of the product thus solution heat treated,
f) the controlled stretching of the product thus quenched until a permanent set of at least 1.5%,
g) the ageing of the product thus stretched at a temperature of between 160 and 180° C.

### DESCRIPTION OF THE FIGURES

FIG. 1: Compromise between the yield strength and the toughness for extruded products of the example.

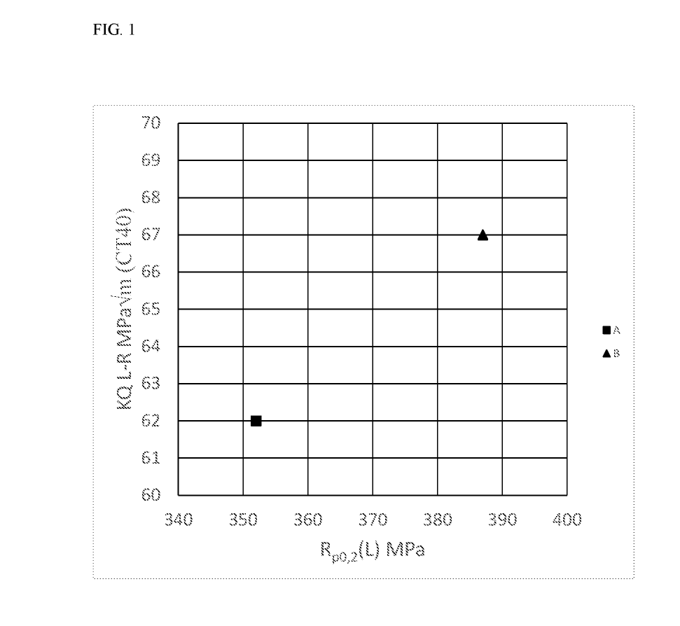

### DESCRIPTION OF THE INVENTION

Unless otherwise specified, all information relating to the chemical composition of the alloys are expressed as a percentage by weight based on the total weight of the alloy. The expression 1.4 Cu means that the copper content expressed as a % by weight is multiplied by 1.4. The naming of the alloys is done, conforming with the regulations of The Aluminium Association, known to those skilled in the art. The definitions of the tempers are indicated in the European standard EN 515.

The static mechanical characteristics in stretching, in other words, the ultimate tensile strength Rm, the conventional tensile yield strength at 0.2% of elongation Rp0.2, and the elongation at fracture A %, are determined by a tensile test according to the standard NF EN ISO 6892-1, the sampling and the direction of the test being defined by the standard EN 485-1.

The stress intensity factor (K_{Q}) is determined according to the standard ASTM E399. The standard ASTM E399 gives criteria which enable to determine if K_{Q} is a valid value of K_{1C}. For a given specimen geometry, the K_{Q} values obtained by different materials are comparable with each other, insofar as the yield strengths of the materials are of the same order of magnitude.

Unless otherwise specified, the definitions of the standard EN 12258 are applied.

The thickness of the extruded products is defined according to the standard EN 2066:2001: the cross-section is divided into basic rectangles of dimensions A and B; A always being the larger dimension of the basic rectangle and with B able to be considered as the thickness of the basic rectangle.

According to the invention, the extruded products made from Al—Cu—Mg alloy that have an improved compromise between mechanical strength and toughness, in particular, in the longitudinal direction, are obtained using a narrow selection of composition and a suitable transformation method, comprising solution heat treatment, quenching, controlled stretching and ageing.

The copper content is between 5.05 and 5.35% by weight. Preferably, the copper content is between 5.10 and 5.30% by weight. Advantageously, the maximum copper content is 5.25% by weight and preferably, 5.20% by weight. The magnesium content is between 0.20 and 0.40% by weight. Preferably, the magnesium content is between 0.25 and 0.35% by weight. The combination of the additions of Cu and Mg with, in particular, a Cu/Mg ratio of between 12.625 and 26.75 contributes to reaching an advantageous compromise between mechanical strength and toughness. Advantageously, the Cu/Mg ratio is between 16 and 21.

The manganese and zirconium contents are controlled to obtain an advantageous granular structure. Thus, a manganese content of 0.20 to 0.40% by weight is associated with a zirconium content of 0.08 to 0.15% by weight. Preferably, the manganese content is between 0.25 and 0.35% by weight. Advantageously, the zirconium content is between 0.10 and 0.14% by weight. The control of additions of manganese and zirconium advantageously enable a non-recrystallised structure to be obtained which is favourable to obtaining the desired compromise between mechanical strength and toughness in the longitudinal direction.

The addition of 0.01 to 0.15% by weight of titanium enables, in particular, to control the grain size during the casting and can contribute to obtaining the favourable property compromise between mechanical strength and toughness.

The alloy can comprise up to 0.15% by weight of zinc, with this addition able to have a favourable effect on the mechanical strength, without any risk for other properties, such as corrosion resistance. In an embodiment of the invention, the zinc content is, however, less than 0.05% by weight.

The iron and silicon contents are maintained respectively below 0.15 and 0.10% by weight, and preferably below 0.09 and 0.08% by weight.

The contents of other elements are each maintained below 0.05% by weight and 0.15% in total. These other elements are impurities unavoidably present in aluminium and their content must be limited to not affect the properties of the alloy.

Advantageously, the chrome and vanadium contents are maintained below 0.02% by weight.

The production range of the extruded product according to the invention comprises the casting of an unwrought product, the homogenising of this unwrought product, the hot forming by extruding of this unwrought, homogenised product, the solution heat treatment, the quenching, the controlled stretching and ageing.

The unwrought product is advantageously a billet, but it can be different insofar as it is possible to obtain a billet from this unwrought product, for example, by machining. The unwrought product is homogenised. In an advantageous embodiment, the unwrought product is homogenised at a temperature of between 490 and 540° C.

The hot forming of a billet obtained from this unwrought, homogenised product is done by extrusion. Advantageously, the exit temperature of the extruded product is at least 440° C. The extruded product thus obtained is solution heat treated at a temperature of between 525 and 540° C. In an embodiment of the invention, the solution heat treatment is done directly using the heat generated during the extrusion.

The extruded product as such solution heat treated is then quenched, for example by spraying or immersion with cold water.

The extruded product as such solution heat treated and quenched then undergoes a controlled stretching until a permanent set of at least 1.5% is achieved, advantageously at least 2%. This controlled stretching step enables to relieve stress of the product and also contributes to the mechanical properties.

The product thus obtained finally undergoes an artificial ageing at a temperature of between 160 and 190° C. for a duration, typically between 5 and 40 hours. Advantageously, the artificial ageing temperature is between 165 and 180° C. for a duration, typically between 10 and 35 hours. Preferably, the ageing temperature is at least 170° C. The temper thus obtained is typically a T8511 temper.

The metallurgic structure obtained is preferably mainly non-recrystallised, with a recrystallisation rate of less than 30%, and most often less than 10%, over the entire thickness.

The extruded products according to the invention advantageously have a yield strength Rp_{0.2} (L) measured at quarter-diameter of at least 365 MPa, preferably at least 375 MPa, and most preferably at least 380 MPa.

The extruded products according to the invention advantageously have a toughness K_{Q} measured according to the standard ASTM E399 in the direction L-R or in the direction L-T for specimens C(T) of thickness B=40 mm and of width W=80 mm sampled at half-diameter of at least 63 MPa√m and preferably at least 65 MPa√m.

The extruded products according to the invention can advantageously be used in the aerospace industry, the automotive industry, lorry and train production, the defence industry and general industrial applications such as ventilation systems, compressors or pistons, in the form of a machined or wrought mechanical component.

These products can, in particular, be used in the extruded state or in the wrought state of an extruded bar. The thickness of the extruded products according to the invention, or the diameter in the case of circular-section bars, is advantageously at least 50 mm and preferably at least 100 mm. The products according to the invention are particularly well suited to use as pistons in an internal combustion engine of a vehicle and, in particular, of a racing car. As an example, the products according to the invention can be used as pistons in internal combustion engines for Formula 1 racing cars. The concept of “Formula 1” refers to a specific sports competition ruling and involves the use of racing cars specifically adapted to this competition.

The products according to the invention can also be used as pistons in other racing vehicles, in particular, in cars, motorcycles or racing ships. The products according to the invention can also be used in vehicles intended for the general public, as well as in commercial vehicles and any other vehicle using an internal combustion engine.

They can also be used in hydraulic or pneumatic installations, in particular, at an increased temperature, typically between 200 and 350° C.

### Example

Two alloys have been prepared, of which the composition is indicated in table 1. Alloy B is an alloy entering into the composition field according to the invention. The alloys have been cast in the form of billets and homogenised at 530° C. for 6 hours.

TABLE 1
Composition of alloys (% by weight)

| Alloy | Si | Fe | Cu | Mn | Mg | Ti | Zr | Zn |
|---|---|---|---|---|---|---|---|---|
| A | 0.04 | 0.08 | 5.18 | 0.34 | 0.21 | 0.11 | 0.02 | 0.08 |
| B | 0.06 | 0.06 | 5.14 | 0.33 | 0.26 | 0.02 | 0.12 | 0.08 |

Circular-section extruded bars with a diameter of 150 mm have been obtained from the billets. The bars thus obtained have been solution heat treated for 6 hours at 533° C., quenched by immersing in water, stress relieved by controlled stretching with a permanent set rate of 3% and aged for 24 hours at 173° C. The temper thus obtained was T8511.

The mechanical characteristics have been measured: ultimate tensile strength Rₘ (in MPa), conventional yield strength at 0.2% Rp_{0.2} (in MPa) and elongation at fracture A (in %), on the circular-section tensile specimens according to the standard ASTM B 557, sampled at quarter-diameter in the directions L and R (4 specimens per case). Also, the toughness by the critical stress intensity factor K_{1c} (in MPa√m) has also been measured, according to the standard ASTM E 399, on the specimens C(T) of thickness B=40 mm and of width W=80 mm sampled at half-diameter in the directions L-R and R-L (2 specimens per case), where L is the main direction of deformation, here the extrusion direction and R is the radial direction.

All the results are grouped together in table 2. The K_{Q} values are not valid K1c values according to the standard ASTM E 399, the criterion Pₘₐₓ/P_{Q}<1.10 not being satisfied, as well as the criterion 2.5(K_{Q}/Rp_{0.2})²>W−a in certain cases.

TABLE 2
Mechanical properties obtained

| | Rₘ | Rp_{0.2} | | Rₘ | Rp_{0.2} | | K_{Q} |
|---|---|---|---|---|---|---|---|
| | (L) | (L) | A % | (R) | (R) | A % | (L-R) |
| Alloy | MPa | MPa | (L) | MPa | MPa | (R) | MPa√m |
| A | 402 | 352 | 16 | 432 | 361 | 11 | 62 |
| B | 439 | 387 | 14 | 442 | 368 | 7 | 67 |

It is observed that alloy B according to the invention leads to a simultaneous improvement of the mechanical strength in the direction L, that is a 10% increase of the yield strength R_{p0.2}(L) and a 9% increase of the rupture load Rₘ(L), and the toughness in the direction L-R, that is a 7% increase of K_{Q}(L-R). With these properties being conflicting, this simultaneous improvement is surprising.

The granular structure of alloy B was mainly non-recrystallised with a recrystallisation rate lower than 10%, whereas that of alloy A was partially recrystallised.

1. Extruded product made from alloy of composition (% by weight):
Cu: 5.05-5.35 Mg: 0.20-0.40 Mn: 0.20-0.40 Zr: 0.08-0.15 Ti: 0.01-0.15 Zn: 0-0.15 Si<0.10 Fe<0.15
and other elements<0.05 each and <0.15 in total, the remainder being Al, treated by solution heat treatment, quenching, controlled stretching and ageing.

2. Extruded product according to claim 1, wherein Si<0.08% and Fe<0.09%.

3. Extruded product according to claim 1, wherein Cu≤5.2%.

4. Extruded product according claim 1, wherein Mg is between 0.25 and 0.35%.

5. Extruded product according to claim 1, wherein Mn is between 0.25 and 0.35%.

6. Extruded product according to claim 1, comprising a yield strength Rp_{0.2} (L) measured at quarter-diameter of at least 365 MPa, optionally at least 375 MPa, and optionally at least 380 MPa.

7. Extruded product according to claim 1, comprising a toughness K_{Q} measured according to the standard ASTM E399 in the direction L-R or in the direction L-T for the specimens C(T) of thickness B=40 mm and of width W=80 mm sampled at half-diameter of at least 63 MPa√m and optionally at least 65 MPa√m.

8. Extruded product according to claim 1, comprising a mainly non-recrystallised granular structure.

9. Method for producing an extruded product according to claim 1 comprising:
a) casting of an unwrought product of the composition,
b) homogenising of said unwrought product to form a homogenised product,
c) hot forming by extrusion of a billet obtained from said unwrought product, and said homogenised product, to obtain an extruded product,
d) solution heat treatment of said extruded product, at a temperature of between 525 and 540° C.,
e) quenching of the product thus solution heat treated,
f) controlled stretching of the product thus quenched until a permanent set of at least 1.5%,
g) ageing of the product thus stretched at a temperature of between 160 and 190° C.

10. Method according to claim 9, wherein the ageing is done at a temperature of at least 170° C.

11. A product comprising an extruded product according to claim 1 as one or more pistons in an internal combustion engine of a vehicle and, optionally, of a racing car.
